(19) United States
(12) Patent Application Publication
(10) Pub. No.: US 2011/0108627 A1
(43) Pub. Date: May 12, 2011

(54) METHOD AND OPTICAL DEVICE FOR ANALYZING A MARK ON A TRANSLUCENT OR TRANSPARENT CURVED WALL

(75) Inventors: Guillaume Bathelet, Marcy L'etoile (FR); Marc Leconte, Loire Sur Rhone (FR)

(73) Assignee: TIAMA, VOURLES (FR)

(21) Appl. No.: 13/000,396

(22) PCT Filed: Jul. 7, 2009
(86) PCT No.: PCT/FR2009/051344

§ 371 Date: Jan. 19, 2011

(30) Foreign Application Priority Data
Jul. 7, 2008 (FR) 08 54615

(51) Int. Cl. G06K 7/10

(52) U.S. Cl. 235/454

(57) ABSTRACT

The invention relates to a method of using a light source (5) possessing a lighting surface (S) and a camera (6) presenting an observation optical axis (A) to analyze a mark (2) made on the outside surface (3₁) of a curved wall (3) made of a material that is translucent or transparent, the method being characterized by:
making the light source extensive and uniform in such a manner that:
   firstly the extent of the virtual image (S′) of the lighting surface (S) of the light source (5) completely covers the surface of the mark (2); and
   the brightness of the virtual image (S′) of the lighting surface (S) of the light source (5) is uniform; and
observing the surface of the mark (2) superposed on the surface of the virtual image (S′) so as to enable the mark (2) to be analyzed.

The invention relates to the technical field of reading a mark in the general sense such as a code, on the outside surface of a curved wall that is made of a material that is translucent or transparent.

The invention finds a particularly advantageous, but non-limiting, application in the field of reading a mark, a sign, or a code provided on the outside wall of a container, in particular a container made of glass or plastics material, such as, for example: a bottle, a jar, a bulb, a vial, an ophthalmic lens, etc.

In the field of reading a mark or a code on the curved wall of an article, document US 2006/0091214 proposes a device having a light source illuminating a diffusing screen that is pierced in its center for positioning the lens of a camera. The axis of the camera is colinear with the axis of the diffusing screen. The diffusing screen is fitted with a diffusing chamber enabling source lighting to be provided that provides multiple angles of incidence for reading the code.

It should be observed that the surface of the diffusing screen presents in its center a lighting-free zone that corresponds to the presence of the camera lens. With articles that produce specular reflections such as a glass surface, for example, the camera observes the source lighting reflected on the surface it is inspecting. The lighting-free zone of the source gives rise to a dark zone in the image that interferes with reading the code.

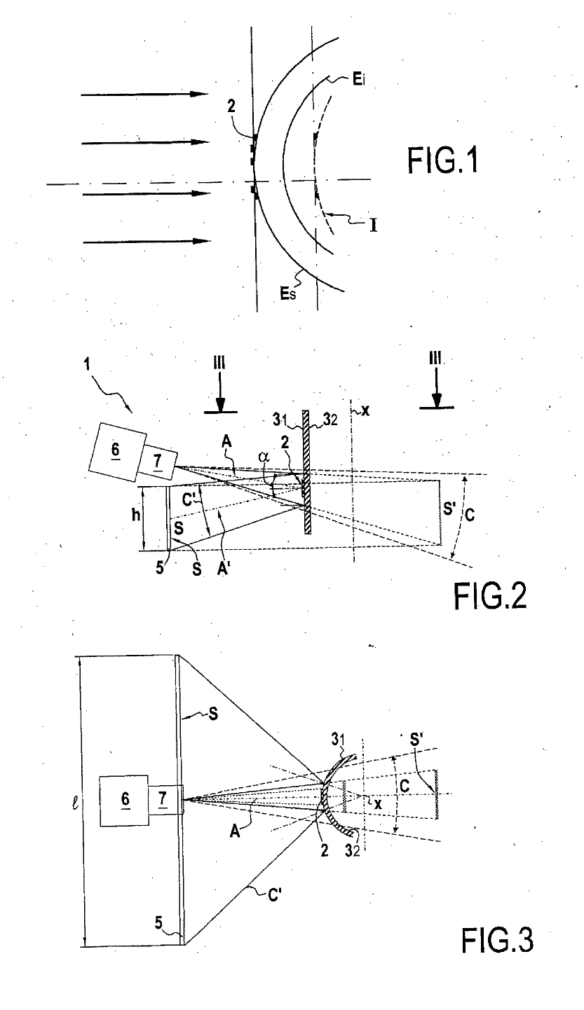

Furthermore, it should be observed that the device described in that document seeks to read a code made on an article that is opaque. As can be seen in FIG. 1, reading a code 2 on an article that is transparent or translucent, presenting two refracting surfaces Es and Ei, gives rise to a specific problem. In this example, the code 2 is marked on the outside reflecting surface Es of the article. There thus appears an image I of the outside surface Es that is formed by reflection on the inside surface Ei of the article. This interfering image obtained by reflection on the inside surface Ei of the article is offset relative to the code, thereby impeding proper detection of the code on the outside surface Es of the article.

In the state of the art, it is also known from patent U.S. Pat. No. 4,644,151 to provide a device that is adapted to read a code on a container and corresponding to the number of the mold from which the container was molded. Such a code comprises a series of portions in relief or “beads”, each presenting a diameter of millimeter order. The code is illuminated by a light source, and its light rays as reflected by the portions in relief are recovered by a linear camera in order to determine the code written on the container. Such a reader device is not adapted to reading a code that presents little or no relief relative to the surface being inspected. Furthermore, such a device is unsuitable for reading a code with very small patterns or characters, e.g., smaller than one millimeter. Furthermore, such a device does not avoid interference from the image that is present as a result of reflection on the inside surface of the container. Finally, such a device requires scanning at constant pitch in order to read the code made over a large angular extent of the container.

The invention thus seeks to remedy the drawbacks of the prior art by providing a novel optical technique adapted to analyzing in reliable manner a mark made up of small patterns or characters and carried on the outside surface of a curved wall made of a material that is reflective and transparent or translucent.

To achieve such an object, the invention proposes a method of using a light source possessing a lighting surface and a camera presenting an observation optical axis to analyze a mark made on the outside surface of a curved wall made of a material that is translucent or transparent.

According to the invention, the method is performed by:
making the light source extensive and uniform in such a manner that:
   firstly the extent of the virtual image of the lighting surface of the light source completely covers the surface of the mark; and
   the brightness of the virtual image of the lighting surface of the light source is uniform; and
observing the surface of the mark superposed on the surface of the virtual image so as to enable the mark to be analyzed.

In a variant implementation, the method consists in observing the surface of the mark by acquiring an image or a series of images taken during relative movement between the camera and the wall.

Advantageously, the method consists in adapting the extent of the virtual image of the lighting surface of the light source to the curvature of the curved wall.

The invention also provides a device for analyzing a mark made on the outside surface of a curved wall made of a material that is translucent or transparent, the device comprising:
a light source possessing a lighting surface; and
a camera provided with a lens having an observation optical axis that is substantially perpendicular to the outside surface of the curved wall.

According to the invention:
the light source possesses a lighting structure that is uniform and extensive such that:
   the extent of the virtual image of the lighting surface of the light source completely covers the surface of the mark; and
   the brightness of the virtual image of the lighting surface of the light source is uniform; and
the camera is adapted to acquire the image of the surface of the mark superposed on the surface of the virtual image.

In a variant embodiment, the light source comprises a back-lit diffusing screen that is offset relative to the lens of the camera.

In an embodiment, a deflector optical element is placed in front of the lens of the camera.

In a variant embodiment, the diffusing screen is extended on either side by mirrors placed facing each other.

In another variant embodiment, the diffusing screen is extended by a mirror extending in a plane that is substantially perpendicular to the planes in which the mirrors and the diffusing screen extend.

In another embodiment, the device includes an optical element between the diffusing screen and the curved wall, the optical element being adapted to form an image of the plane of the surface of the source in the plane of the pupil of the lens of the camera.

In another embodiment, the device includes a semitransparent optical element interposed between the lens of the camera and the curved wall, a diffusing screen being positioned symmetrically to the inlet pupil of the lens of the camera relative to the plane of the semitransparent optical element.

Advantageously, the mark is marking obtained by laser.

Various other characteristics appear from the following description made with reference to the accompanying drawings, which show embodiments of the invention as non-limiting examples.

FIG. 1 is a diagram explaining the problem of interfering images that can be solved by means of the invention.

FIG. 2 is an elevation view showing the principle on which an analysis device in accordance with the invention operates.

FIG. 3 is a plan view substantially on line III-III of FIG. 2.

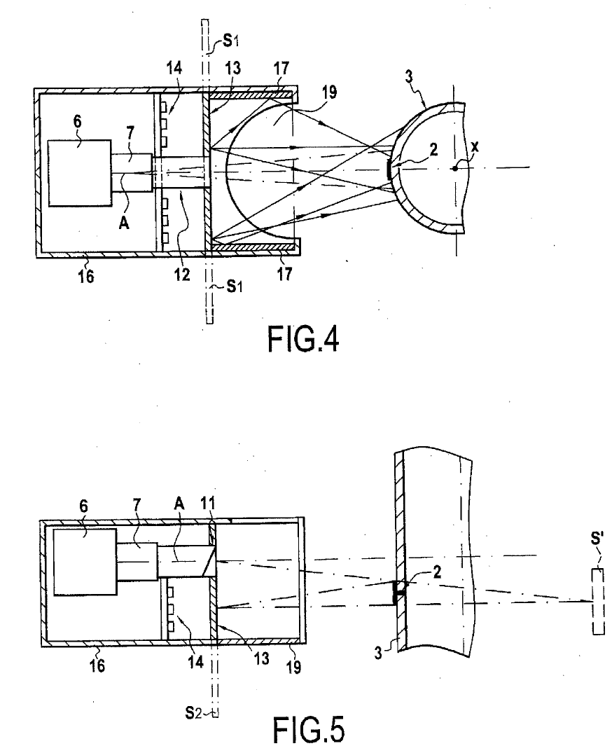

FIGS. 4 and 5 are respectively a plan view and an elevation view of a variant embodiment of an analysis device implemented a prism.

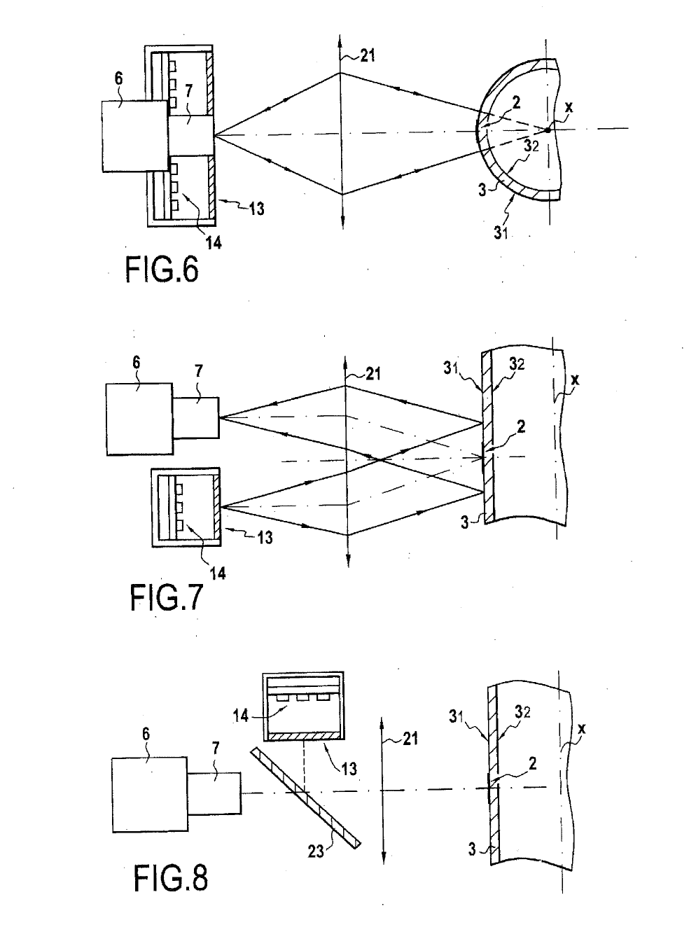

FIGS. 6 and 7 are respectively a plan view and an elevation view of another embodiment of an analysis device implementing a Fresnel lens.

FIG. 8 is an elevation view of another embodiment of an analysis device implementing a beam splitter.

As can be seen in FIGS. 2 and 3, the invention provides a device 1 adapted to analyze optically a sign, a mark, or more generally marking 2 of any kind made on the outside surface 3₁ of a curved wall 3 of an article presenting two refractive surfaces 3₁, 3₂ such as ophthalmic lens or a hollow article (container, bulb, tube, etc.). The mark 2 is made deliberately in any appropriate manner (by depositing ink, laser marking, etc.) and may present various one- or two-dimensional forms such as for example a bar code, an alphanumeric code, or a data matrix.

The wall 3 is made of a material that is reflective and transparent or translucent. For example, the wall 3 is made of glass or of plastics material. The wall 3 has two refracting surfaces corresponding to the outside surface 3₁ and the inside surface 3₂ of the article. The outside surface 3₁ extends substantially parallel to the inside surface 3₂ that thus co-operates with the outside surface 3₁ to define the thickness of the wall of the article. The outside surface 3₁ is a specular surface since it behaves like a mirror.

It should be observed that the device 1 of the invention seeks to analyze the mark 2 made on a non-plane wall 3, i.e. a wall that presents any shape that is curved. In the example shown in FIGS. 2 and 3, the wall 3 presents a semi-cylindrical shape. In a transverse plane perpendicular to the surfaces 3₁ and 3₂, the outside surface 3₁ presents determined curvature, such as a segment of a circle that is centered on a longitudinal axis x, in the example shown. The longitudinal axis x is a straight line, since the wall 3 is a portion of a cylinder, however it is possible to envisage the wall 3 also presenting curvature in the plane perpendicular to the transverse plane of the camera 6.

The device 1 includes a light source 5 and a camera 6 conventionally provided with a lens 7 having an observation optical axis A and an optical field of view C. Naturally, the optical field of view C of the camera 6 is adapted to cover or observe at least the entire area of the mark 2 made on the outside surface 3₁ of the curved wall, with the camera 6 conventionally being a matrix camera.

The light source 5 possesses a uniform and extensive lighting surface S for lighting the outside surface 3₁ that, given its specular nature, creates a virtual image S′ of the lighting surface S by reflection. The virtual image S′ thus corresponds to the surface of the light source 5 as seen by the camera after reflection on the outside surface 3₁.

In FIG. 3, for reasons of clarity, the image S′ is shown as being in the same position as in FIG. 2. In this representation, the astigmatism of the convex mirror constituted by the outside surface 3₁ is ignored. In reality, if the outside surface 3₁ is a mirror that can be thought of as a cylindrical mirror about the axis x, and of radius R, then the virtual image of a horizontal segment of the lighting surface S contained in the section plane of FIG. 3 would be a horizontal segment S′ situated at a distance close to R/2, i.e. closer to the outside surface 3₁, while continuing to be a virtual image on the same side of the outside surface 3₁. Likewise because of astigmatism, for a complete analysis it should also be understood that the position S′ of the virtual image S in FIG. 2 corresponds to the image of a vertical segment of the lighting surface S lying in the section plane of FIG. 2.

In accordance with the invention, the light source 5 possesses a lighting surface that is uniform and extensive. The light source 5 is such that:
the extent of the virtual image S′ completely covers the surface area of the mark 2; and
the brightness of the virtual image S′ is uniform.

It should be considered that the brightness of the virtual image S′ of the source is uniform, i.e. that it does not include zones of shade.

Furthermore, the virtual image S′ covers the entire surface area of the mark 2. Thus, the area of the virtual image S′ is not less than the area of the mark 2. In practice, and preferably, the area of the virtual image S′ is greater than the area of the mark 2 so as to be certain that, regardless of relative movements between the device 1 and the article, the surface of the mark 2 is completely covered by the surface of the virtual image S′. Preferably, the area of the virtual image S′ is at least 1.5 times greater than the area of the mark 2.

It should be understood that the camera 6 observes the virtual image S′ of the surface S of the light source 5 as a background to the mark 2. This mark 2 and the virtual image S′ are contained in the field of view C with the mark 2 being contained within the virtual image S′.

It should be observed that the light source 5 is such that the intensity of the virtual image S′ is sufficient to constitute a background that is not disturbed by interfering lighting. The light source 5 may be a pulsed source or a continuous source.

The dimensioning of the surface S of the light source 5 stems directly from the above description. The camera 6 observes in its optical field C the surface of the virtual image S′ of the reflected light source. The extension C′ of the optical field of view C serves to define the dimensions (height h and width l) of the surface S of the light source 5. In the example shown, the width l of the surface S lies in the transverse plane, i.e. it is perpendicular to the surfaces 3₁ and 3₂, whereas the height h is taken along the longitudinal axis x.

Advantageously, the surface S of the light source 5 is centered on the image A′ of the observation axis A after reflection on the outside surface 3₁.

According to an advantageous characteristic of the invention, the observation direction, i.e. the observation optical axis A of the camera, is substantially perpendicular to the outside surface 3₁ of the wall. The observation incident angle α is thus small because the image A′ of the observation axis A after reflection on the outside surface 3₁ is also substantially perpendicular to the outside surface 3₁. The observation optical axis A and the image A′ of the observation optical axis A after reflection are substantially parallel. In the meaning of the invention, the observation optical axis A is substantially parallel to the image A′ of the observation axis insofar as the angle between them is less than or equal to 10° (α≦5°) and is preferably typically equal to 6° (α=3°). Insofar as the observation direction is perpendicular to the outside surface 3₁, the secondary image of the outside surface formed by reflection on the inside surface 3₂ coincides with the main image of the outside surface 3₁, so that the interfering images corresponding to duplication of the mark 2 do not appear.

As can be seen from the invention, the camera 6 is adapted to acquire the image of the surface of the mark 2 superposed on the virtual image S′ of the source. In other words, the camera 6 is adapted to observe the mark 2 superposed on the virtual image S′. The mark 2 and the virtual image S′ are substantially in alignment on the observation axis A.

The image acquired by the image 6 is processed by a processor unit adapted to analyze or read the mark 2. Given the lighting and the observation conditions as described above, there are no interfering images in the image taken, in which image the mark 2 appears with good uniform contrast enabling the mark to be read reliably.

FIGS. 4 and 5 show a first embodiment of the device in accordance with the invention in which an optical element 11 such as a prism is placed in front of the camera lens 7 in order to deflect the observation optical axis A so as to make the device 1 more compact. For example, the lens 7 is extended by a tube 12 having the prism 11 mounted at its end.

In this embodiment, the light source 5 has a diffusing screen 13 that is back-lit by a light emitter 14, e.g. implemented as a series of light-emitting diodes (LEDs). The diffusing screen 13 that defines the lighting surface S is offset relative to the camera lens 7. In other words, the diffusing screen 13 is separate from the camera 6. In this illustrated embodiment, the diffusing screen 13 is situated beneath the prism 11, i.e. the diffusing screen 13 is offset relative to the lens 7 along the longitudinal axis x of the article. Naturally, it is possible to envisage positioning the diffusing screen and the prism differently, by pivoting the assembly through 180°, such that the diffusing screen 13 is situated above the prism 11.

Advantageously, the camera 6 and its lens 7 extended by the tube 12 is mounted in an open box 16 so that the observation optical axis prior to deflection by the prism 11 is perpendicular to the longitudinal axis x of the article. The diffusing screen 13 is positioned beneath the prism 11, with the normal to the surface S being perpendicular to the longitudinal axis x of the article. The LEDs 14 are mounted behind the diffusing screen 13.

The diffusing screen 13 is extended on either side by mirrors 17 that are positioned to artificially increase the area of the light source 5 in a privileged direction, and in the example shown specifically in a direction that is horizontal, lying in the plane that is tangential to the curved outside surface 3₁. The surface S of the light source 5 is thus increased on either side by a surface S₁ corresponding to the virtual image of the surface S as reflected in the mirrors 17. By way of example, the mirrors 17 face each other and are parallel to the longitudinal axis x, extending the diffusing screen 13. The presence of the mirrors 17 makes it possible to increase artificially the area of the diffusing screen 13 in a horizontal direction that is perpendicular to the longitudinal axis x. Thus, for a given width of box 16, the area of the light source 5 is extended horizontally (width l), since it corresponds to the surface area S of the light source 5 plus the two surface areas S₁ of the mirrors 17. The presence of mirrors makes it possible to increase observation along the periphery or the circumference of the article without increasing the size of the light source 5 in the width direction.

The invention thus enables the extent of the virtual image S′ of the lighting surface S of the light source 5 to be adapted to the curvature of the curved wall 3. Thus, the greater the curvature of the wall 3 (the smaller its radius of curvature) the greater the width l of the surface of the light source 5.

In another variant embodiment, it should be observed that provision may be made to increase the surface area of the light source 5 artificially in a second direction, i.e. along the vertical axis x. In this example, the diffusing screen 13 is extended by a mirror 19 lying in a plane that is substantially perpendicular to the planes in which the mirrors 17 extend and the plane in which the diffusing screen 13 extends. The surface area of the light source 5 is thus increased in the vertical plane by an area S₂ corresponding to the virtual image of the surface S resulting from reflection on the mirror 19.

FIGS. 6 and 7 show another embodiment in which the analysis device 1 includes an optical element 21 between the diffusing screen 13 and the curved wall 3, the optical element 21 being adapted to form the image of the plane of the surface S of the light source 5 in the plane of the pupil of the lens 7 of the camera 6. The optical element 21, such as a Fresnel lens, thus serves to combine the plane of the light source 5 with the longitudinal axis x of the article. After reflection on the outside surface 3₁ of the wall, the light rays are combined by the lens at the pupil of the lens 7. Thus, in the image, the surface S of the light source 5 appears as being uniform and extensive in a horizontal direction included in the plane tangential to the curved outside surface 3₁.

In this example, the camera 6 provided its lens 7 is placed above the diffusing screen 13 that is back-lit by the LEDs 14 so that the observation and lighting optical axes, prior to passing through the Fresnel lens 21, are mutually parallel. It should be observed that the observation and lighting axes form an angle of less than 10° as a result of using the Fresnel lens 21, thus making it possible to avoid casting shadows.

FIG. 8 shows another embodiment in which the observation and lighting axes are colinear. In this example, the surface of the screen 13 diffusing the light source is observed by the camera after being reflected on the outside surface 3₁ of the wall. In order to ensure that, after reflection on the wall, this surface of the diffusing screen 13 appears as being extensive in the horizontal direction, a Fresnel lens 21 may be placed for example between the lens 7 and the wall, so as to cause the plane of the light source to coincide with the longitudinal axis of the article. After reflection on the outside surface of the wall, the light rays are combined by the Fresnel lens 21 at the pupil of the lens 7. Thus, the surface of the diffusing screen 13 appears in the image as being uniform and extensive in a horizontal direction included in the plane tangential to the curved outside surface 3₁.

It should be observed that the observation optical axis A is perpendicular to the longitudinal axis x of the article. For the observation and lighting optical axes to be colinear, a semitransparent optical element 23 is interposed between the lens 7 of the camera 6 and the outside surface 3₁ of the curved wall. In this example, the back-lit diffusing screen 13 is positioned symmetrically with the inlet pupil of the lens 7 of the camera 6 relative to the plane of the semitransparent optical element 23.

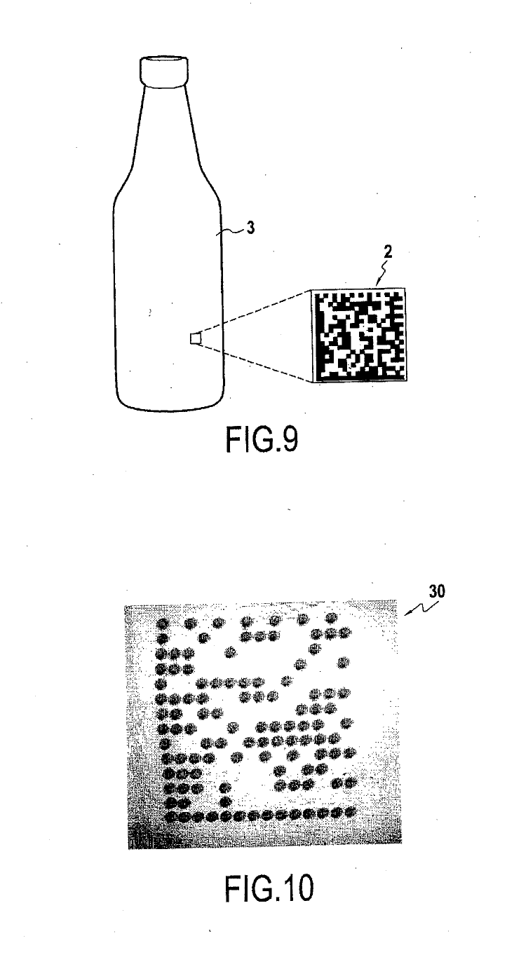

From the above description, it can be seen that the device 1 in accordance with the invention serves to acquire a mark 2 on a reflecting and transparent wall under good conditions. The device 1 of the invention finds a particularly advantageous application in reading a two-dimensional mark 2 such as a matrix code formed on the wall 3 of a glass container, as can be seen in FIG. 9. Preferably, the matrix code is a data matrix code made on a container while hot, by laser etching. As can be seen in FIG. 10, the device 1 of the invention serves to acquire an image 30 of the surface of the code 2 superposed on the virtual image of the light source. The background of the image 30 is pale since it is constituted by the image of the light source as reflected by the wall. The various points of the code 2 deflect light and therefore appear dark in the image 30. The light source illuminates an annular sector that includes the complete code, and as explained above it presents uniformity in two directions, i.e. parallel to and perpendicular to the vertical axis of the article. As can be seen clearly in FIG. 10, the image as obtained in this way presents good resolution.

Furthermore, such a device 1 is compact, thus making it possible for it to be implemented in the form of a portable reader device, or making it easy for it to be integrated in a machine for in-line inspection of articles. It should be observed that provision may be made to observe the mark 2 by acquiring a single image or a series of successive images during relative movement between the camera and the wall, e.g. movement in rotation. With relative movement, the images, which may overlap, are analyzed together in order to read the mark 2.

The invention is not limited to the examples described and shown since various modifications can be applied thereto without going beyond its ambit.

1. A method of using a light source (5) possessing a lighting surface (S) and a camera (6) presenting an observation optical axis (A) to analyze a mark (2) made on the outside surface (3₁) of a curved wall (3) made of a material that is translucent or transparent, the method being characterized by:
making the light source extensive and uniform in such a manner that:
firstly the extent of the virtual image (S′) of the lighting surface (S) of the light source (5) completely covers the surface of the mark (2); and
the brightness of the virtual image (S′) of the lighting surface (S) of the light source (5) is uniform; and
observing the surface of the mark (2) superposed on the surface of the virtual image (S′) so as to enable the mark (2) to be analyzed.

2. A method according to claim 1, characterized in that it consists in observing the surface of the mark (2) by acquiring an image or a series of images taken during relative movement between the camera and the wall.

3. A method according to claim 1, characterized in that it consists in adapting the extent of the virtual image (S′) of the lighting surface (S) of the light source (5) to the curvature of the curved wall (3).

4. A device for analyzing a mark (2) made on the outside surface (3₁) of a curved wall (3) made of a material that is translucent or transparent, the device comprising:
a light source (5) possessing a lighting surface (S); and
a camera (6) provided with a lens (7) having an observation optical axis (A) that is substantially perpendicular to the outside surface (3₁) of the curved wall;
the device being characterized in that:
the light source (5) possesses a lighting structure (S) that is uniform and extensive such that:
the extent of the virtual image (S′) of the lighting surface (S) of the light source completely covers the surface of the mark (2); and
the brightness of the virtual image (S′) of the lighting surface (S) of the light source (5) is uniform; and
the camera (6) is adapted to acquire the image of the surface of the mark (2) superposed on the surface of the virtual image (S′).

5. A device according to claim 4, characterized in that the light source (5) comprises a back-lit diffusing screen (13) that is offset relative to the lens (7) of the camera (6).

6. A device according to claim 5, characterized in that a deflector optical element (11) is placed in front of the lens (7) of the camera (6).

7. A device according to claim 4, characterized in that the diffusing screen (13) is extended on either side by mirrors (17) placed facing each other.

8. A device according to claim 7, characterized in that the diffusing screen (13) is extended by a mirror (19) extending in a plane that is substantially perpendicular to the planes in which the mirrors (17) and the diffusing screen (13) extend.

9. A device according to claim 5, characterized in that it includes an optical element (21) between the diffusing screen (13) and the curved wall, the optical element (21) being adapted to form an image of the plane of the surface of the source in the plane of the pupil of the lens (7) of the camera (6).

10. A device according to claim 4, characterized in that it includes a semitransparent optical element (23) interposed between the lens (7) of the camera (6) and the curved wall, a diffusing screen (13) being positioned symmetrically to the inlet pupil of the lens (7) of the camera (6) relative to the plane of the semitransparent optical element (23).

11. A device according to claim 4, characterized in that the mark (2) is marking obtained by laser.
